(19) United States
(12) Patent Application Publication
(10) Pub. No.: US 2006/0021058 A1
(43) Pub. Date: Jan. 26, 2006

(54) Double key protection method for computer peripheral and architecture for the same

(75) Inventor: Cheng Chih Yuan, Taipei (TW)

Correspondence Address: TROXELL LAW OFFICE PLLC, SUITE 1404, 5205 LEESBURG PIKE, FALLS CHURCH, VA, 22041, US

(73) Assignee: Advantech Co., Ltd.

(21) Appl. No.: 11/011,147

(22) Filed: Dec. 15, 2004

(30) Foreign Application Priority Data
Jul. 20, 2004 (TW) 93121627

(51) Int. Cl. H04N 7/16

(52) U.S. Cl. 726/26

(57) ABSTRACT

A double key protection method is adapted to computer peripherals and architecture for the same. The present invention equips at least one microprocessor and one storage unit on a computer peripheral, and executes a client program in the computer. A first key is used to check whether the computer peripheral is copyrighted and a second key is used to check whether the client program is copyrighted. The software designer should set a first key value and store the first key value in a storage unit, and then indicate a second key value. Then the microprocessor executes a key procedure and produces a first cyclic redundancy check and programs the second key value and the first cyclic redundancy check into the client program. When operating the client program, the client program can be checked for copyright by checking the first cyclic redundancy check.

### BACKGROUND OF THE INVENTION

1. Field of the Invention

The present invention relates to a double key protection method for computer peripherals and architecture for the same. It especially relates to a double key protection method and architecture by using a first key to protect the computer peripheral hardware and a second key to protect the client program.

2. Description of Prior Art

The mostly common used mechanism for protection of a modern computer and network is a secret code. The designers of the computer peripheral apparatus usually use a secret code to protect their own hardware or software, such as the computer video interface card and some application program or driver for the computer interface card.

FIG. 1 shows the traditional signal key protection architecture for a traditional computer interface card. In traditional protection architecture, as shown in FIG. 1, a computer interface card 10 usually has a microprocessor 11 and a storage unit 12 that stores a control program. When a computer 20 is operating the computer interface card 10, the computer will execute at least one client program 21 and an interface program 22, such as a driver program, to control the computer interface card 10 through an interface unit 23 (PCI interface card).

In order to protect the computer interface card 10, the client program 21 and the interface program 22, the designer will set a code verification mechanism in the computer interface card 10. In code verification mechanism the interface program 21 of the computer 20 will send a key value 100 to the microprocessor 11. The microprocessor 11 will compare the key value 100 with the key value 100 inside the storage unit 12. If the key value 100 inside the storage unit 12 is correct, the microprocessor 11 will tell the client program 21 that the client program 21 and the computer interface card 10 are copyrighted. If the key value 100 is incorrect, this means that either the interface program 22 or the computer interface card 10 is a fake.

The advantage of the protection mechanism mentioned above is that the program is composed easily and cheap. But the designer must make a fixed key value for each computer interface card 10. As the number of computer interface cards increases, so do the storage costs. Therefore, most designers will make the client program and the key value in a single CD, corresponding to only one computer interface card.

If the producer of the computer interface card 10, the designer of the client program 21 or the interface program 22 are different, the producer of the computer interface card 10 will provide the key value to the software designer. But an embezzler only needs to purchase the computer interface card 10.

Therefore, an embezzler will have competitive superiority over those who purchase both copyrighted hardware and software.

Therefore, the inventor of the present invention invents a double key protection mechanism. The client can set their own second key value to protect their products.

### SUMMARY OF THE INVENTION

It is the object of the present invention to provide a double key protection method for computer peripherals and architecture for the same. The present invention allows software designers to set their own key value, without the necessity of setting different key values for each interface card. It both protects the software designer's product and lowers their costs.

To achieve the above objectives, the present invention provides a double key protection method for computer peripherals. The present invention sets a microprocessor and a memory device in a computer peripheral apparatus, and executes a client program which operates alongside the computer peripheral apparatus in the computer. The methods of the present invention first indicate a first key value previously stored in the memory device, and indicate a second key value. After the microprocessor takes the first key value in operation and produces a first cyclic redundancy check, it then writes the second key value and the first cyclic redundancy check in the client program. When the client program is executed, the second key value is transferred to the microprocessor and produces a second cyclic redundancy check, and finally returns the cyclic redundancy check to the client program to check with the first cyclic redundancy check. Therefore, the software can be verified whether or not it is copyrighted.

The present invention also provides a double key protection architecture for computer peripherals, which comprises a computer peripheral apparatus and a recorder, the computer peripheral apparatus has a microprocessor and a memory device and an interface unit. The recorder connects to the computer peripheral apparatus and records the first key value in the memory device; the interface unit connects to the computer and inputs a second key value to the microprocessor through a client program and reads the preserved first key value to produce a second cyclic redundancy check. It then compares the first cyclic redundancy check with the second cyclic redundancy check to verify a copyrighted device.

### BRIEF DESCRIPTION OF THE DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a traditional single key protection architecture diagram;

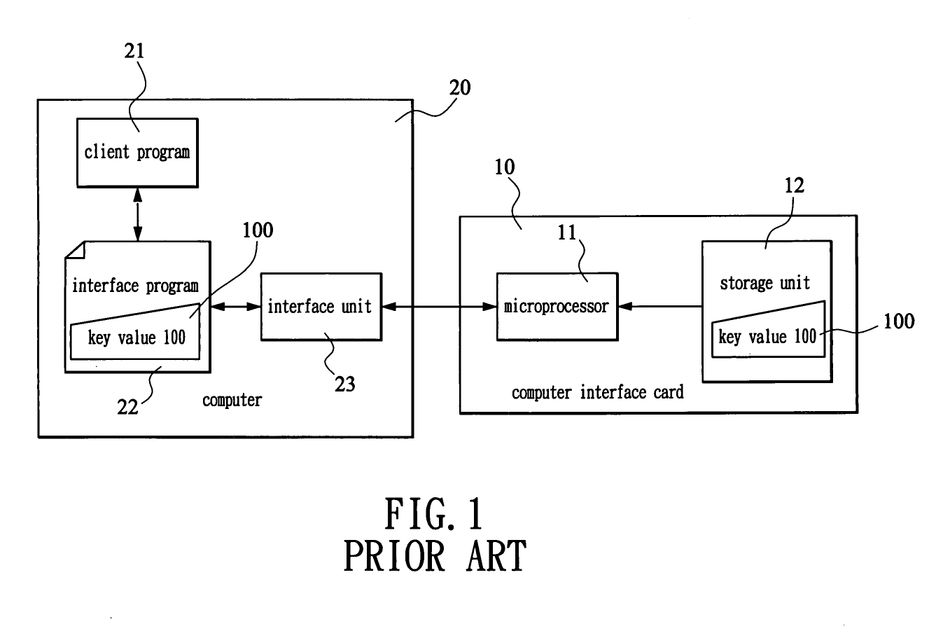

FIG. 2 shows the double key protection architecture diagram of the present invention;

FIG. 3 shows the first key examination flow chart of the present invention;

FIG. 4 shows the second key examination flow chart of the present invention;

FIG. 5 shows the state diagram for setting the second key;

FIG. 6 shows the second key checking flow chart of the present invention; and

FIG. 7 shows the state diagram for checking the second key.

### DETAIL DESCRIPTION OF THE INVENTION

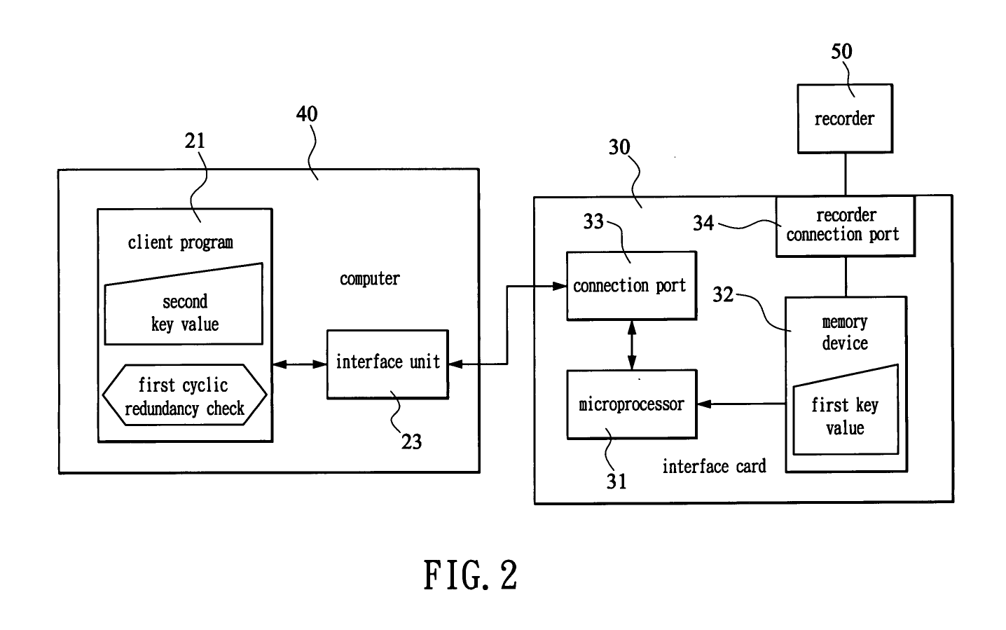

Please refer to FIG. 2 first, which shows the double key protection architecture for a computer peripheral of the present invention. The present invention designs a double key protection procedure based on the traditional single key protection mechanism. The present invention protects the client program which operates alongside the computer peripheral. The traditional single key protection mechanism uses a single fixed value. In this way, it reduces costs. But they also can use a non-fixed value.

The computer peripheral mentioned in the present invention can be an interface device which plugs into a computer, such as a TV card; it can also be a peripheral device such as a TV box connected outside the computer. The computer peripheral connects to the computer through an input/output interface. The input/output interface can be a PCI interface or an AGP interface if the computer peripheral is a TV card. The input/output interface also can be a USB interface if the computer peripheral is a TV box.

FIG. 2 shows the computer interface card 30 as a preferred embodiment. The computer interface card 30 comprising at least one microprocessor 31 one memory device 32 one interface unit 33 and one recorder connection port 34, wherein the memory device 32 can be an electrically erasable programmable read-only memory (EEPROM) or a flash memory.

The interface unit 33 is connected to the input/output interface 23 of the computer 40. If the computer interface card 30 is plugged into a PCI bus and the computer 40 has a client program 41, the client program 41 can be the driver of the computer interface card 30 or an application program. Therefore, the computer 40 can execute a specific procedure with the computer interface card 30.

The recorder connection port 34 connects to a recorder 50, and the programmers can utilize the recorder 50 to record a key value in the memory device 32.

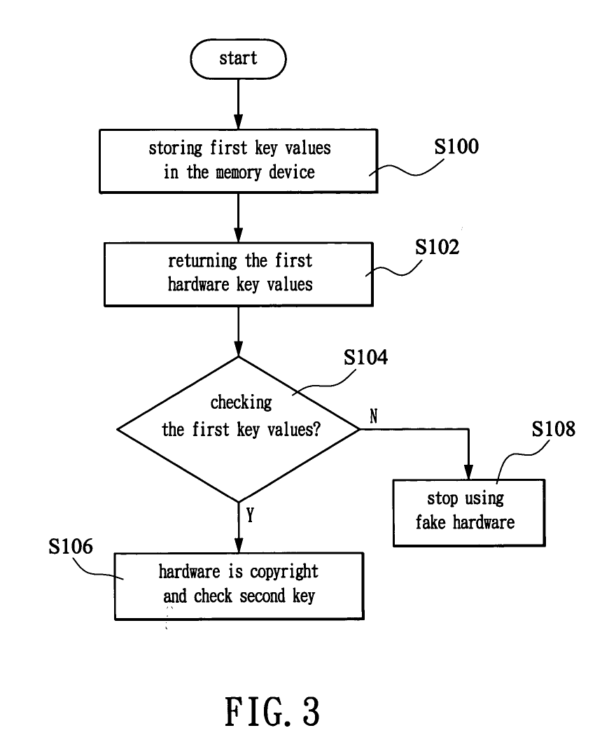

Please refer to FIG. 3. FIG. 3 shows a first key examination flow chart of the present invention. The designers of the computer interface card must provide a set of first hardware key values which can be of fixed values. The first hardware key values must be stored in the memory device 32 in step S100. The first hardware key values are used to protect the computer interface card 30, so the client program 41 asks the computer interface card 30 to return the first hardware key values in step S102 when using the computer interface card. In step S104, the computer will check the first hardware key values, if the first hardware key values are correct, the computer interface card 30 is copyrighted so the computer will then go to step S106 to check for the second key values.

If the first hardware key values are incorrect, the computer interface card 30 is a fake and the computer will stop using the computer interface card 30 in step S108.

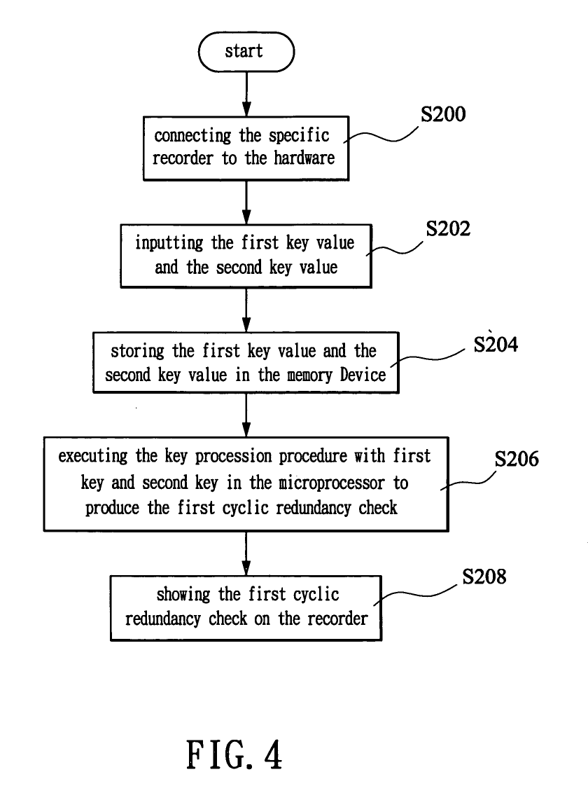

The second key of the present invention is used to protect the client program or some application programs which both operate alongside the computer interface card. FIG. 4 shows a second key examination flow chart of the present invention. For extra protection, the second key has at least two key values to increase the security of the software. The software designer can use a specific recorder 50 to store these key values in the memory device 32 of the interface card 30.

In the computer interface card 30 of the present invention, the microprocessor 31 processes a key operation procedure. The key operation procedure needs at least the first key value and the second key value to produce a first cyclic redundancy check. The software designer connects the specific recorder 50 to the computer recorder port 34 of the interface card 30 when setting key values in step S200.

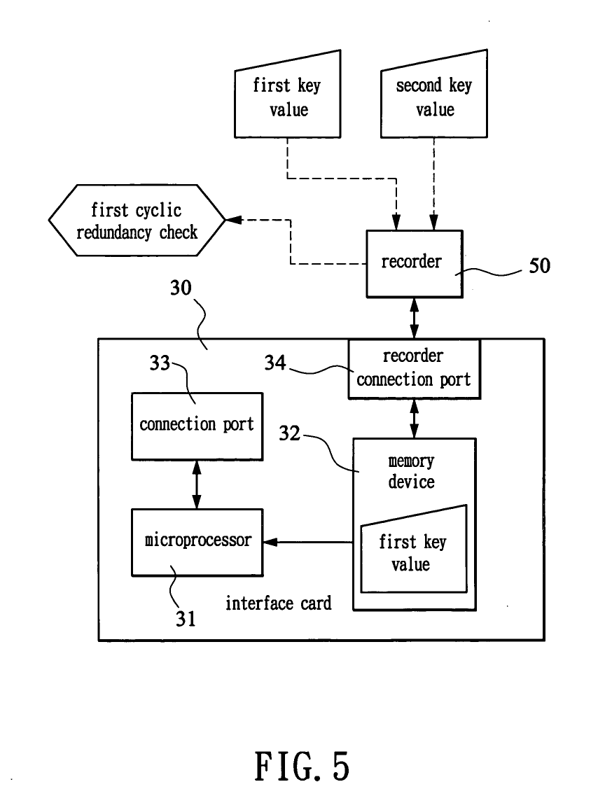

FIG. 5 shows the state diagram for setting the second key of the present invention. The present invention uses the recorder 50 to input the first key value and the second key value, the recorder 50 stores the first key value and the second key value in the memory device 32 in step S204.

The present invention executes the key procession procedure to produce the first cyclic redundancy check and stores the information on the recorder 50. Thereafter, the software designers can remove the recorder 50 and program the second key value and the first cyclic redundancy check in the client program 41 in step S300so the client program can check whether it is copyrighted.

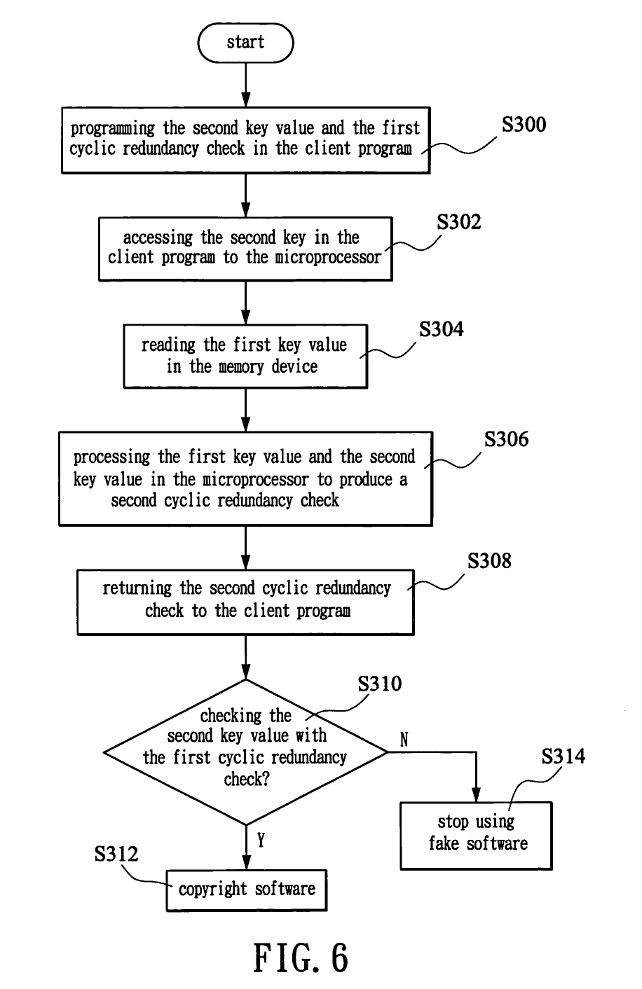

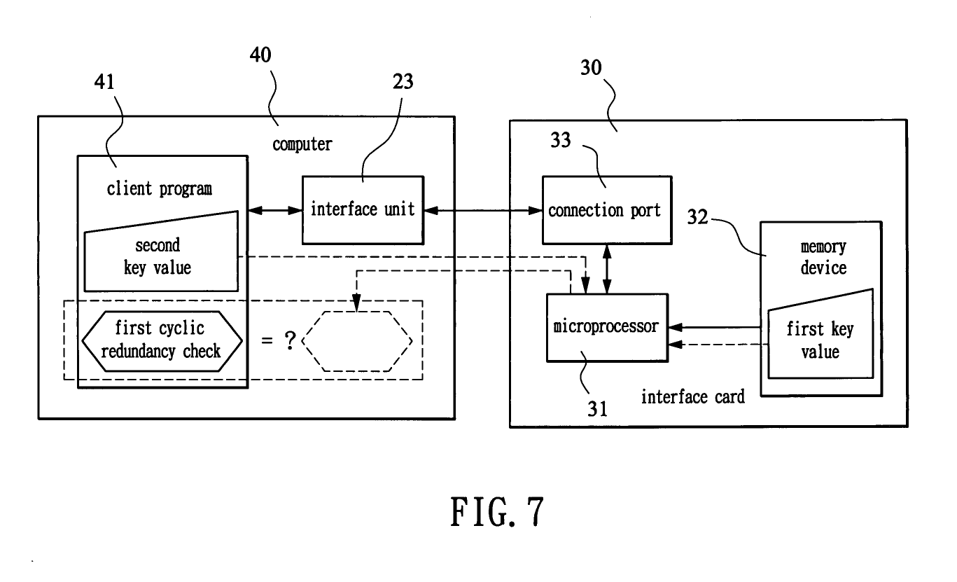

FIG. 6 shows the second key checking flow chart of the present invention while FIG. 7 shows the state diagram for checking the second key. When software designers develop the computer interface card 30, the client program 41 calls a client program 41 to read the second key in the client program 41 in step S302. The interface program also transfers the second key to the microprocessor 31 of the computer interface card 30.

After the microprocessor 30 accepts the second key value and reads the first key value in the memory device 32 in step S304, the first key value and the second key value will be processed by the key procession procedure and produce a second cyclic redundancy check in step S306.

Finally, the microprocessor 31 returns the second cyclic redundancy check to the interface program in step S308. The second cyclic redundancy check is compared with the first cyclic redundancy check when operating the interface program in step S310. If the first cyclic redundancy check and the second cyclic redundancy check are the same, the client program 41 is copyrighted; if not, the client program is a fake and the computer will stop using the computer interface card or tell the user to perform an appropriate action.

Because the first key value and the second key value are both set by the software designer, even if the software thief breaks the first key in the computer interface card 30, they still can not obtain the second key value. Therefore, the software and hardware are both protected by the double key protection architecture.

Although the present invention has been described with reference to the preferred embodiment thereof, it will be understood that the invention is not limited to the details thereof. Various substitutions and modifications have suggested in the foregoing description, and others will occur to those of ordinary skill in the art. Therefore, all such substitutions and modifications are intended to be embraced within the scope of the invention as defined in the appended claims.

What is claim is:

1. A double key protection method for computer peripherals, which sets a microprocessor and a memory device in a computer peripheral, and processes a client program in a computer peripheral, comprising of the following steps:
indicating a first key value which is stored in the memory device;
indicating a second key value which is processed with the first key in the microprocessor, then produces a first cyclic redundancy check;
writing the second key value and the first cyclic redundancy check in the client program;
executing the client program to transfer the second key value to the microprocessor;
operating the first key value and the second key value in the microprocessor to produce a second cyclic redundancy check, and
returning the second cyclic redundancy check to the client program to compare with the first cyclic redundancy check, to examine the copyrighted client program.

2. The double key protection method for computer peripheral as in claim 1, before indicating the first key there also comprising the steps as follows:
providing a hardware key value which is stored in the memory device;
returning the hardware key value to the client program when using the computer peripheral; and
examining the hardware key value to verify a copyrighted computer peripheral.

3. The double key protection method for computer peripherals as in claim 2, wherein the hardware key value is provided by the producer of the computer peripheral, the hardware key value can be a fixed value.

4. The double key protection method for computer peripheral as in claim 1, before indicating the first key further comprising steps as follows:
connecting a specific recorder with the computer peripheral.

5. The double key protection method for computer peripherals as in claim 1, in the indicating first key value step, the first key value is stored in the memory device by a specific recorder.

6. The double key protection method for computer peripheral as in claim 1, wherein the memory device is an EEPROM or a flash memory.

7. A double key protection architecture for computer peripherals, which is used in a computer peripheral and operates alongside a client program in the computer, the architecture comprising:
a microprocessor set in the computer peripheral, the microprocessor is used to operate a first key value and a second key value to produce a cyclic redundancy check;
a memory device set in the computer peripheral, the memory is used to store the first key value;
a recorder connecting to the computer peripheral, the recorder is used to write the first key value in the memory device; and
an interface unit set in the computer peripheral to connect to the computer, the interface unit inputs the second key value to the microprocessor, the microprocessor takes the first key value and the second key value into procession and produce the second cyclic redundancy check, returning the second cyclic redundancy check to the client program, and comparing the first cyclic redundancy check with the second cyclic redundancy check to identify a copyrighted client program and a copyrighted computer peripheral.

8. The double key protection architecture for computer peripheral as in claim 7, wherein the memory device is an electrically erasable programmable read-only memory (EEPROM) or a flash memory.

9. The double key protection architecture for computer peripheral as in claim 7, wherein the interface unit is an input/output interface.

10. The double key protection architecture for computer peripheral as in claim 9, wherein the input/output interface is a PCI interface an AGP interface or a USB connection interface.

11. The double key protection architecture for computer peripheral as in claim 7, wherein the computer peripheral can be an interface card plugged into the computer or a peripheral device which is connected outside the computer.
